(19) United States
(12) Patent Application Publication
(10) Pub. No.: US 2004/0201431 A1
(43) Pub. Date: Oct. 14, 2004

(54) Nonreciprocal circuit element, communication apparatus, lead frame for nonreciprocal circuit element, and method for manufacturing nonreciprocal circuit element

(75) Inventor: Hitoshi Onishi, Niigata-ken (JP)

Correspondence Address: Brinks Hofer Gilson & Lione, P. O. Box 10395, Chicago, IL, 60610, US

(73) Assignee: Alps Electric Co., Ltd.

(21) Appl. No.: 10/810,210

(22) Filed: Mar. 26, 2004

(30) Foreign Application Priority Data
Apr. 8, 2003 (JP) 2003-104114

(51) Int. Cl. H01P 1/36

(52) U.S. Cl. 333/24.2

(57) ABSTRACT

An isolator includes a rectangular parallelepiped enclosure which contains a magnetic assembly and a permanent magnet. The magnetic assembly includes a magnetic plate, a common electrode on the magnetic plate, and central conductors on the magnetic plate. The length of a long side of the enclosure is 3.5 mm or less. Independent terminals which are connected to at least one of the central conductors are disposed in the contour of the enclosure.

### BACKGROUND OF THE INVENTION

1. Field of the Invention

The present invention relates to a nonreciprocal circuit element such as an isolator and a circulator, a communication apparatus, a lead frame for a nonreciprocal circuit element, and a method for manufacturing a nonreciprocal circuit element.

2. Description of the Related Art

A lumped-constant isolator, a type of nonreciprocal circuit element, is a high-frequency component for allowing a signal to pass in the transmission direction without loss while blocking a signal traveling in the reverse direction. It is typically used in a transmission circuit of a mobile communication apparatus such as a mobile phone. Such a lumped-constant isolator typically includes a metal enclosure composed of a top yoke and a bottom yoke of soft iron, the two yokes being integrated with each other. The enclosure contains, for example, a magnetic assembly and a permanent magnet, where the magnetic assembly typically includes a magnetic plate, a common electrode mounted on the magnetic plate, and central conductors mounted on the magnetic plate. The surfaces of the top and bottom yokes have a low-resistivity silver plating layer to decrease noise and to increase the wettability of the solder used for mounting.

A typical process for producing the bottom yoke of the isolator is described in U.S. Pat. NO. 6,469,588 as follows. First, a part which is later to form the bottom yoke and cut-and-raised pieces are formed on a hoop by die-cutting, the entire surface of the hoop is then plated with silver, the cut-and-raised pieces are integrated with the part which is to form the bottom yoke by insert molding, and finally the cut-and-raised pieces and the part which is to form the bottom yoke are cut off the frame part. In this process, the cut-and-raised pieces are formed into input/output terminals and ground terminals.

In the isolator described in U.S. Pat. NO. 6,469,588, the cut-and-raised pieces are cut off the frame part only after the hoop has been plated with silver, and therefore the cut surfaces of the cut-and-raised pieces are unplated. These unplated surfaces decrease the solderability during mounting, and accordingly lead to a poor connection. Furthermore, the unplated surfaces, which are exposed soft iron, may be a source of corrosion. If the isolator described above is used as a component in a communication apparatus, the generated corrosion may become displaced and cause an internal short circuit. In addition, independent terminals and ground terminals of a conventional isolator typically protrude out of the contour of the enclosure. In particular, when the length of a long side of the enclosure is 3.5 mm or less, these protruding terminals measurably add to the footprint of the isolator itself when it is mounted on a circuit board.

Furthermore, in the isolator described in U.S. Pat. NO. 6,469,588, the ends of the cut-and-raised pieces are made so as to fit in the cutouts of the bottom yoke when the cut-and-raised pieces are folded by 180°. The depths of these cutouts are larger than the widths. In other words, a large part of the bottom yoke, which functions as a magnetic circuit, is cut out. This may adversely affect the bias magnetic field. Furthermore, since the widths of the cut-and-raised pieces are small and hence the contact areas between the resin and the cut-and-raised pieces are small, there is risk of the cut-and-raised pieces becoming detached from the bottom yoke when the cut-and raised pieces are insert-molded with the resin.

### SUMMARY OF THE INVENTION

Accordingly, an object of the present invention is to provide a nonreciprocal circuit element which has a small mounting footprint and corrosion-free terminals with superior solderability and to provide a communication apparatus including such a nonreciprocal circuit element. Another object of the present invention is to provide a lead frame suitable for the manufacture of a nonreciprocal circuit element having corrosion-free terminals with superior solderability. Still another object of the present invention is to provide a method for manufacturing a nonreciprocal circuit element having corrosion-free terminals with superior solderability.

According to one aspect of the present invention, a nonreciprocal circuit element includes a parallelepiped enclosure, a permanent magnet disposed in the enclosure, and a magnetic assembly disposed in the enclosure. The magnetic assembly includes a magnetic plate, a common electrode on the magnetic plate, and a plurality of central conductors on the magnetic plate. The length of a long side of the enclosure is 3.5 mm or less and a pair of independent terminals connected to at least one of the central conductors are disposed substantially in the contour of the enclosure. In addition to the independent terminals, ground terminals are preferably disposed in the contour of the enclosure.

Because the enclosure is 3.5 mm or less, the footprint of the nonreciprocal circuit element as mounted on a circuit board can be reduced.

In the nonreciprocal circuit element, the enclosure may include a top yoke and a bottom yoke which includes two parallel side plates defining side wall surfaces of the enclosure. The bottom yoke may include cutouts of which the width is larger than the depth, the width direction of the cutouts being substantially identical to the direction of the side wall surfaces. The independent terminals may be disposed in the cutouts and the bottom yoke may be integrated with the independent terminals with resin.

Since the extent of the cutouts is small, that is, the area of the bottom yoke is large, the attenuation of the bias magnetic field becomes small. Because of this, a sufficient bias field can be applied to the magnetic assembly even when the permanent magnet is made small.

In the nonreciprocal circuit element, each of the independent terminals may include a terminal body and a bent terminal segment formed by bending one end of the terminal body and the longitudinal direction of the terminal body may be aligned with the width direction of the corresponding cutout.

Since the extent of the cutouts is small and therefore large contact areas between the terminal bodies and the resin can be secured, the independent terminals can be firmly fixed to the bottom yoke.

In the nonreciprocal circuit element, each of the bent terminal segments is preferably exposed to the outside of the corresponding side wall surface of the enclosure. Thus, the nonreciprocal circuit element can be connected to an external circuit via the bent terminal segments.

In the nonreciprocal circuit element, the entire surface of each of the bent terminal segments may have an anti-corrosion plating layer. The bent terminal segments are more easily solderable and therefore the nonreciprocal circuit element can be firmly connected to an external circuit. Furthermore, the occurrence of corrosion at the bent terminal segments is prevented.

In the nonreciprocal circuit element, the other end of each of the terminal bodies may be exposed to the outside of the corresponding side wall surface and the entire surface of each of the terminal bodies, except for the exposed portion, may have an anti-corrosion plating layer. Furthermore, at least one part of the exposed portion preferably has an anti-corrosion coating layer. Thus, the occurrence of corrosion at the terminal bodies is prevented.

According to another aspect of the present invention, a communication apparatus includes one of the nonreciprocal circuit elements described above.

According to another aspect of the present invention, a lead frame for a nonreciprocal circuit element includes a hoop including a pair of side divisions and a bottom yoke section between the side divisions. Each of the side divisions includes a fold section formed by die-cutting a portion of the side division into a substantial bold U shape, the fold section including a support segment extending from an inner edge toward an outer edge of the portion of the side division and an independent terminal segment formed at an end of the support segment. The independent terminal segments are wider than the support segments. The bottom yoke section includes a pair of cutouts of which the width is larger than the depth, wherein each of the independent terminal segments is positionally symmetrical with the corresponding cutout with respect to a fold line of the corresponding fold section.

According to another aspect of the present invention, a lead frame for a nonreciprocal circuit element includes a hoop including a pair of side divisions and a bottom yoke section between the side divisions. The bottom yoke section includes a pair of cutouts of which the width is larger than the depth. Each of the side divisions includes a fold section formed by die-cutting a portion of the side division into a substantial bold U shape and bent towards the bottom yoke section. Each of the fold sections includes a support segment extending from an inner edge of the portion and an independent terminal segment formed at an end of the support segment. The independent terminal segments are wider than the support segments, and the independent terminal segments are disposed in the respective cutouts. The entire surface of the lead frame preferably has an anti-corrosion plating layer.

The bottom yoke provided with the independent terminals is produced by cutting the independent terminal segments off the support segments after insert molding by injecting resin between the independent terminal segments and the cutouts on the lead frame. Here, the cut surfaces are unplated because they are cut after plating. According to the lead frame, the widths of the independent terminal segments are smaller than those of the support segments. Because of this, only some portions of the independent terminal segments are unplated surfaces as a result of cutting, that is, the external surfaces of the independent terminal segments still have a plating player. High solderability results and corrosion is prevented from occurring by using these plated portions as input/output terminals. Furthermore, large contact areas between the terminal bodies and the resin are secured, and therefore the independent terminals can be firmly fixed to the bottom yoke. In addition, since the extent of the cutouts is small, that is, the area of the bottom yoke is large, the attenuation of the bias magnetic field can be reduced.

In the lead frame for a nonreciprocal circuit element, each of the independent terminal segments may include a terminal body and a bent terminal segment formed by bending one end of the terminal body, the support segment being joined with the other end of the terminal body.

Thus, cut surfaces, which are unplated, are formed on the other ends of the terminal bodies, while the entire surfaces of the bent terminal segments still have a plating layer. Therefore, the bent terminal segments are more easily solderable and the occurrence of corrosion at the bent terminal segments is prevented.

In the lead frame for a nonreciprocal circuit element, each of the bent terminal segments is preferably perpendicular to the bottom yoke section.

In the lead frame for a nonreciprocal circuit element, each of the fold sections may further includes a notch between the support segment and the independent terminal segment. This makes it easy to cut the independent terminal segments off the support segments.

According to another aspect of the present invention, a method for manufacturing a nonreciprocal circuit element includes the steps of die-cutting a hoop to form a bottom yoke section having a pair of cutouts of which the width is larger than the depth and a pair of fold sections each including a support segment and an independent terminal segment wider than the support segment, the bottom yoke section being joined with the fold sections by the hoop; folding each of the fold sections towards the bottom yoke section such that each of the independent terminal segments is disposed in the corresponding cutout by aligning the longitudinal direction of the independent terminal segment with the width direction of the cutout; integrally insert-molding the bottom yoke section and the independent terminal segments with resin; and cutting off the bottom yoke section and the independent terminal segments from the hoop to produce a bottom yoke.

According to the present invention, a nonreciprocal circuit element which has a small mounting footprint and corrosion-free terminals with superior solderability can be provided.

### BRIEF DESCRIPTION OF THE DRAWINGS

FIG. 1 is a perspective view of an isolator according to an embodiment of the present invention;

FIG. 2 is an exploded perspective view of an isolator according to an embodiment of the present invention;

FIG. 3 is a plan view of a bottom yoke of an isolator according to an embodiment of the present invention;

FIG. 4 is a front view of a bottom yoke of an isolator according to an embodiment of the present invention;

FIG. 5 is a side view of a bottom yoke of an isolator according to an embodiment of the present invention;

FIG. 6 is a circuit diagram of a communication apparatus including an isolator;

FIG. 7 is a plan view of a lead frame for an isolator according to an embodiment of the present invention;

FIG. 8 is a front view of a lead frame for an isolator according to an embodiment of the present invention;

FIG. 9 is a side view of a lead frame for an isolator according to an embodiment of the present invention;

FIG. 10 is a perspective view of a fold section after being folded;

FIG. 11 is a plan view illustrating a method for manufacturing a bottom yoke of an isolator according to an embodiment of the present invention;

FIG. 12 is a side view of the illustration in FIG. 11;

FIG. 13 is a plan view illustrating a method for manufacturing a bottom yoke of an isolator according to an embodiment of the present invention; and

FIG. 14 is a graph showing the relationship among the depth of a cutout, the bias magnetic field in a magnetic plate, and out-of-band attenuation.

### DESCRIPTION OF THE PREFERRED EMBODIMENTS

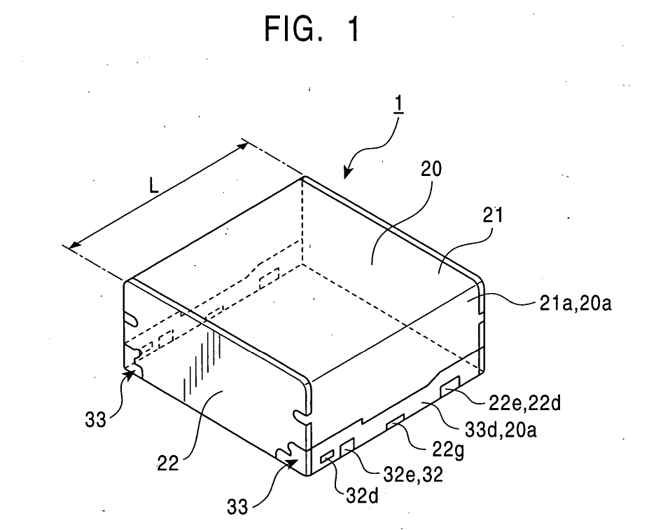

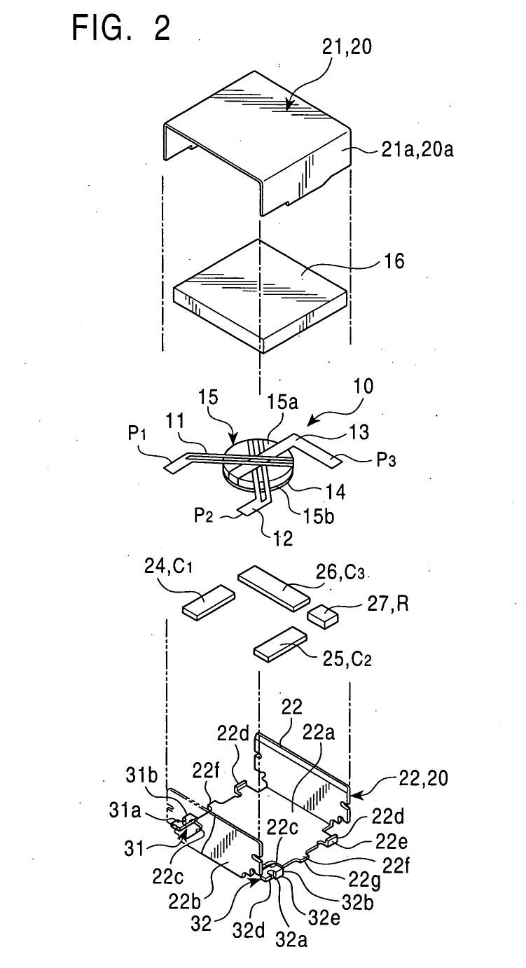

Embodiments according to the present invention will now be described with reference to the attached drawings. FIG. 1 is a perspective view of an isolator according to an embodiment of the present invention. FIG. 2 is an exploded perspective view of the isolator. An isolator 1 (nonreciprocal circuit element) includes an enclosure 20 which contains a magnetic assembly 10 and a permanent magnet 16. The enclosure 20 is composed of a top yoke 21 and a bottom yoke 22. The top yoke 21 includes two side plates 21a parallel to each other, each of which constitutes a side wall surface 20a of the enclosure 20 as described later. The magnetic assembly 10 is disposed above a base 22a of the bottom yoke 22, and the top yoke 21 is disposed above the magnetic assembly 10. The length of a long side of the enclosure 20 (for example, a length L in FIG. 1) is 3.5 mm or less. As shown in FIG. 2, the enclosure 20 contains plate capacitors 24, 25, and 26 and a chip resistor 27. The plate capacitors 24, 25, and 26 include matching capacitor elements C1, C2, and C3, respectively. The chip resistor 27 includes a terminating resistor element R. The isolator 1 functions as a circulator without the chip resistor 27.

As shown in FIG. 2, the magnetic assembly 10 includes a magnetic plate 15 made of ferrite shaped like a flat disk; a common electrode 14 in the form of a metal disk, substantially the same shape as the magnetic plate 15 and provided on a bottom surface 15b of the magnetic plate 15; and first, second, and third central conductors 11, 12, and 13. Each of the three central conductors 11, 12, and 13 extends radially in a different direction from the center of the common electrode 14 and is bent along the magnetic plate 15 over a top surface 15a of the magnetic plate 15. On the top surface 15a, the three central conductors 11, 12, and 13 cross one another substantially at an angle of 120° relative to one another. The magnetic plate 15 is insulated from each of the central conductors 11, 12, and 13 by an insulating sheet (not shown in the figure). The ends of the central conductors 11, 12, and 13 are provided with ports P1, P2, and P3, respectively, such that the ports P1, P2, and P3 extend sideward of the magnetic plate 15. The common electrode 14 is electrically connected to the base 22a of the bottom yoke 22.

Hot electrodes of the matching capacitor elements C1, C2, and C3 are connected to the ports P1, P2, and P3, respectively. Cold electrodes of the matching capacitor elements C1, C2, and C3 are connected to the bottom yoke 22. One electrode of the terminating resistor element R is connected to the hot electrode of the matching capacitor element C3 via the port P3. The other electrode of the terminating resistor element R is connected to the bottom yoke 22. Thus, the terminating resistor element R and the matching capacitor element C3 are connected to each other in parallel.

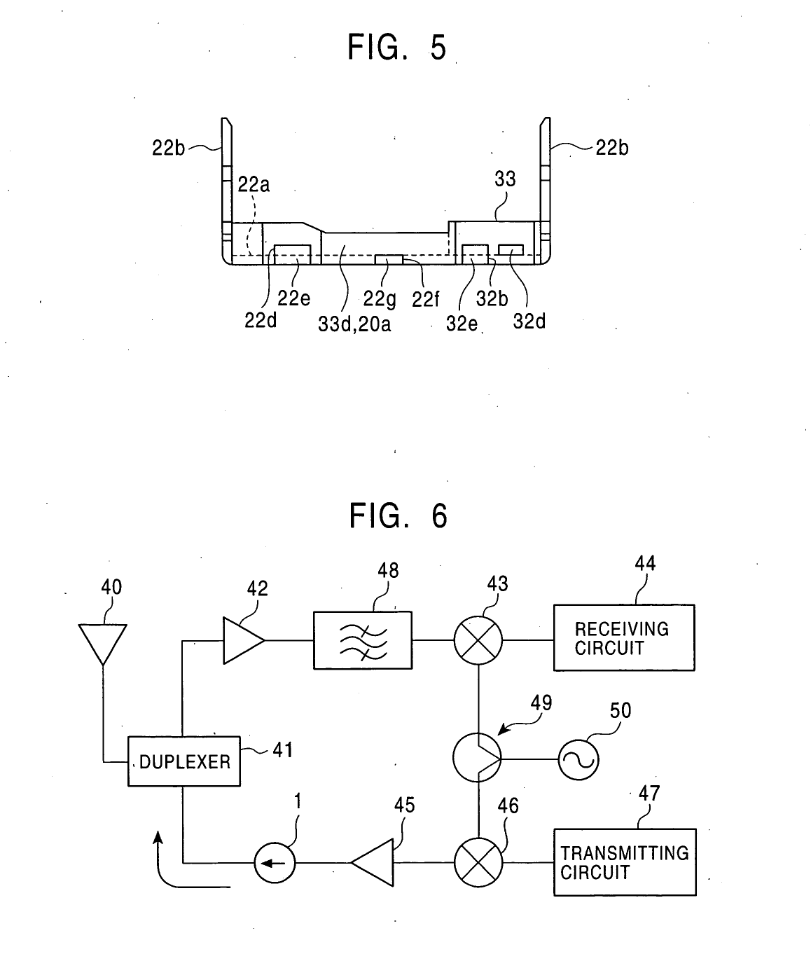

The bottom yoke 22 is made of soft iron plated with Ag or Au. Referring to FIGS. 2 to 5, the bottom yoke 22 includes the base 22a and a pair of walls 22b disposed at both ends of the base 22a. The walls 22b face each other and are disposed perpendicular to the base 22a. The base 22a is provided with a pair of cutouts 22c. One of the cutouts 22c accommodates an independent terminal 31 and the other accommodates an independent terminal 32.

Referring to FIG. 1 and FIGS. 3 to 5, resin casings 33 are insert-molded on the bottom yoke 22. As shown in FIGS. 2 to 5, one end of each of the resin casings 33 extends into the corresponding cutout 22c. The independent terminals 31 and 32 are thereby held in the bottom yoke 22, insulated from and integrated with the bottom yoke 22 through the resin casings 33. The resin casings 33 each form a part 33d of the corresponding side wall surface 20a of the enclosure 20. In detail, as shown in FIG. 1, the side plates 21a of the top yoke 21 fit to the resin casings 33 such that the part 33d of each of the resin casings 33 and the corresponding side plate 21a combine to form the corresponding side wall surface 20a of the enclosure 20.

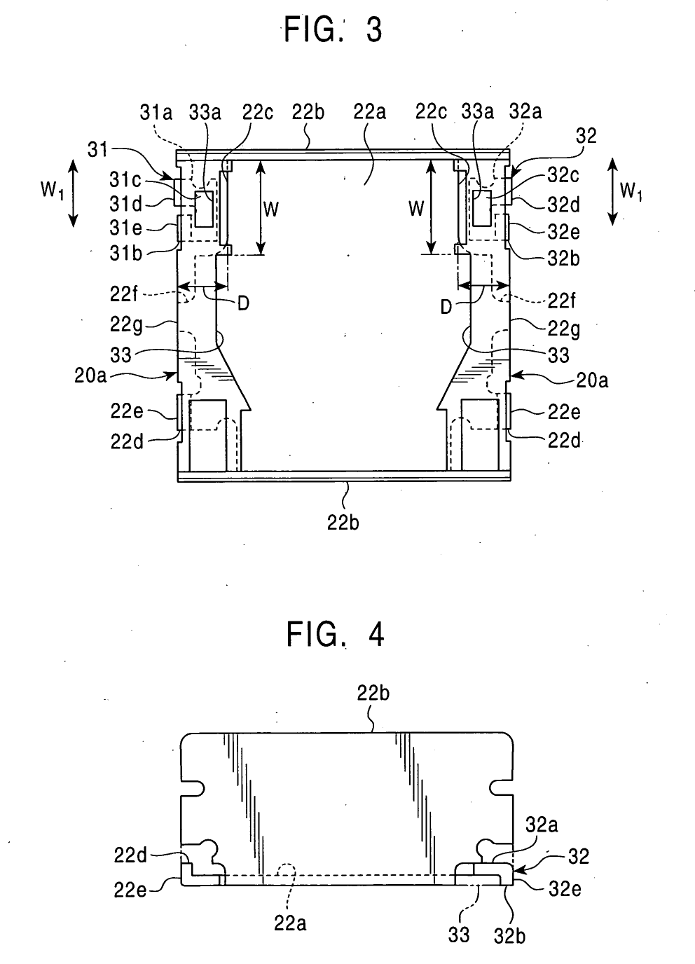

Referring to FIG. 3, a width W of each of the cutouts 22c is larger than a depth D of the cutout 22c, where the direction of the width W extends along the corresponding side wall surface 20a of the enclosure 20. Because the width W is larger than the depth D, the extent of the cutouts in the base 22a is small. In the case of an isolator 3.5 mm² or less, the depth D preferably ranges from 0.2 mm to 0.45 mm, and the length W preferably ranges from 0.4 mm to 1.0 mm.

Referring to FIGS. 1 to 5, the independent terminal 31 includes a terminal body 31a and a bent terminal segment 31b which is formed by bending one end of the terminal body 31a. Similarly, the independent terminal 32 includes a terminal body 32a and a bent terminal segment 32b which is formed by bending one end of the terminal body 32a. The independent terminals 31 and 32 are disposed in the respective cutouts 22c such that the longitudinal direction W₁ of the terminal bodies 31a and 32a is parallel to the width direction of the respective cutouts 22c.

Referring to FIG. 3, a part 31c of the terminal surface of the terminal body 31a and a part 32c of the terminal surface of the terminal body 32a are exposed through windows 33a provided in the respective resin casings 33. The port P1 of the first central conductor 11 and the port P2 of the second central conductor 12 are connected to the parts 31c and 32c, respectively. The input and output terminals of the isolator 1 are thus defined by the independent terminals 31 and 32. As shown in FIGS. 1 to 5, the terminal bodies 31a and 32a have cut surfaces 31d and 32d, respectively. The cut surfaces 31d and 32d are exposed to the outside of the resin casings 33 defining the side wall surfaces 20a of the enclosure 20. The entire surfaces of the terminal bodies 31a and 32a, except for the cut surfaces 31d and 32d, have an anti-corrosion plating layer such as Ag, Au, or solder. That is, the metal underneath the plating layer, such as pure iron, is exposed on the cut surfaces 31d and 32d. The cut surfaces 31d and 32d have an anti-corrosion coating layer, which is not shown in the figures.

The bent terminal segments 31b and 32b are perpendicular to the base 22a of the bottom yoke 22. Terminal surfaces 31e and 32e of the bent terminal segments 31b and 32b are exposed to the outside of the resin casings 33 defining the side wall surfaces 20a of the enclosure 20. The terminal surfaces 31e and 32e are connected to an external circuit. The entire surfaces of the bent terminal segments 31b and 32b have an anti-corrosion plating layer such as Ag, Au, or solder.

The base 22a of the bottom yoke 22 is provided with a pair of ground terminals 22d, which are bent perpendicular to the base 22a. The ground terminals 22d are formed in the respective resin casings 33. Terminal surfaces 22e of the ground terminals 22d are exposed to the outside of the side wall surfaces 20a of the enclosure 20.

The base 22a of the enclosure 20 is provided with a pair of cut sections 22f. Each of the cut sections 22f has another cut surface 22g. The cut surfaces 22g are exposed to the outside of the side wall surfaces 20a of the enclosure 20. The cut surfaces 22g also have an anti-corrosion coating layer, which is not shown in the figures.

As described above, in the isolator 1 according to this embodiment, the independent terminals 31 and 32 and the ground terminals 22d are formed in the resin casings 33 defining the side wall surfaces 20a of the enclosure 20. That is, the independent terminals 31 and 32 and the ground terminals 22d do not protrude from the side wall surfaces 20a defining the contour of the enclosure 20. Hence, the independent terminals 31 and 32 and the ground terminals 22d are disposed in the contour of the enclosure 20. Because of this, the footprint of the isolator 1 as mounted on a circuit board is identical to the area of the bottom surface of the isolator 1. In short, the footprint of the isolator 1 as mounted on a circuit board can be greatly decreased. In particular, since a long side of the enclosure 20 is 3.5 mm or less, the mounting footprint of the isolator 1 can be 12.3 mm² or less.

Furthermore, since the extent of the cutouts 22c is small, that is, the area of the bottom yoke 22 is large, the attenuation of the bias magnetic field becomes small. Because of this, a sufficient bias field can be applied to the magnetic assembly 10 even when the permanent magnet 16 is made small. In particular, if the thickness of the permanent magnet 16 is reduced, the maximum overall height of the isolator 1 can also be reduced, and therefore the size of the isolator 1 can be reduced.

Furthermore, since the longitudinal direction W₁ of the terminal bodies 31a and 32a is made parallel to the width direction W of the cutouts 22c, the contact areas between the terminal bodies 31a and 32a and the corresponding resin casing 33 can be made large. Because of this, even when the extent of the cutouts 22c is made small, the independent terminals 31 and 32 can be firmly secured to the bottom yoke 22. Furthermore, since the entire surfaces of the bent terminal segments 31b and 32b have an anti-corrosion plating layer, the bent terminal segments 31b and 32b become more easily solderable, and therefore an external circuit can be connected securely to the isolator 1. In addition, corrosion can be prevented from occurring at the bent terminal segments 31b and 32b. Furthermore, since the terminal bodies 31a and 32a have an anti-corrosion plating layer and the cut surfaces 31d and 32d have an anti-corrosion coating layer, corrosion at the terminal bodies 31a and 32a can be prevented.

FIG. 6 is an example of a circuit of a mobile phone (communication apparatus) including the isolator 1. In this circuit, a duplexer 41 is connected to an aerial 40; a receiving circuit (IF circuit) 44 is connected to an output of the duplexer 41 via a low-noise amplifier 42, an inter-stage filter 48, and a selection circuit (mixer) 43; a transmitting circuit (IF circuit) 47 is connected to an input of the duplexer 41 via the isolator 1, a power amplifier 45, and a selection circuit (mixer) 46; and a local oscillator 50 is connected to the selection circuits (mixers) 43 and 46 via a distributing transformer 49.

The isolator 1 described above, which is used in a circuit of the mobile phone shown in FIG. 6, allows signals from the isolator 1 to the duplexer 41 to pass at low insertion loss, but causes high insertion loss with signals from the duplexer 41 to the isolator 1 to block such signals in that direction. Thus, the isolator 1 prevents undesired signals such as noise in the duplexer 41 from entering the amplifier 45 in the reverse direction.

This communication apparatus includes the isolator 1 where the entire surfaces of the bent terminal segments 31b 32b have a plating layer. The bent terminal segment 31b and 32b are more easily solderable, and therefore the isolator 1 can be firmly connected to a circuit of the communication apparatus. Furthermore, the bent terminal segments 31b and 32b are resistant to corrosion, and therefore circuit wires are not short-circuited as a result of corrosion becoming displaced. Consequently, the reliability of the communication apparatus can be increased.

A lead frame used to manufacture the bottom yoke 22 of the isolator 1 will now be described.

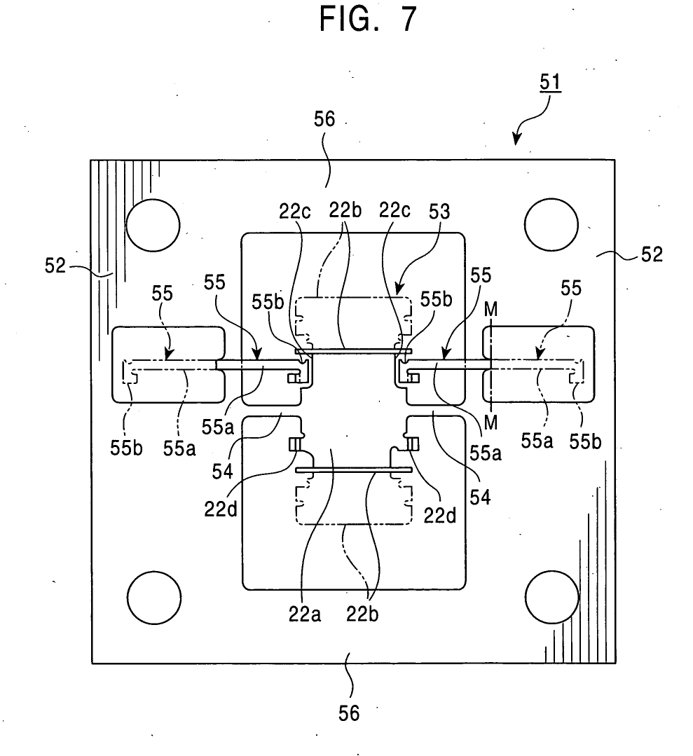

Referring to FIGS. 7 to 10, a lead frame 51 for the isolator 1 is made of a hoop including a bottom yoke section 53 between a pair of side divisions 52. The bottom yoke section 53 is coupled with the side divisions 52 by joints 54. Each of the side divisions 52 is provided with a fold section 55 formed by die-cutting a portion of the side division into a substantial bold U shape. The side divisions 52 are joined with each other by bridges 56. The lead frame 51 for the isolator 1 is formed by die-cutting a magnetic metal plate, such as soft iron, about 0.09 mm to 0.2 mm in thickness into a predetermined shape, bending it, and applying its entire surface with a solder-wettable anti-corrosion plating layer. The types of plating include Ag, Au, or the like, Ag or Au over Cu, or solder plating.

The bottom yoke section 53 becomes the bottom yoke 22 of the isolator 1 and includes the base 22a and a pair of the walls 22b. The walls 22b are perpendicular to the base 22a. The base 22a is provided with the pair of cutouts 22c whose widths are larger than the depths. The cutouts 22c are disposed near the joints between the base 22a and a wall 22b. The bottom yoke section 53 is provided with the ground terminals 22d integrated with the bottom yoke section 53. The ground terminals 22d are bent perpendicular to the bottom yoke section 53.

As shown in FIGS. 7 to 10, each of the fold sections 55 includes a support segment 55a which extending from an inner edge toward an outer edge of the portion of the side division 52 and an independent terminal segment 55b formed at an end of the support segment 55a. The fold sections 55 are formed such that the independent terminal segments 55b are accommodated in the cutouts 22c of the bottom yoke section 53 when the fold sections 55 are folded at fold lines M, which are the joints between the support segments 55a and the side divisions 52. In short, the independent terminal segments 55b are positionally symmetrical with the cutouts 22c with respect to the fold lines M. When the fold sections 55 are unfolded as indicated by dashed lines in FIG. 7, the fold sections 55 protrude in the direction opposite to the bottom yoke section 53. On the other hand, when the fold sections 55 are folded as indicated by solid lines, the fold sections 55 are accommodated in the cutouts 22c of the bottom yoke section 53. The independent terminal segments 55b are not in contact with the bottom yoke section 53.

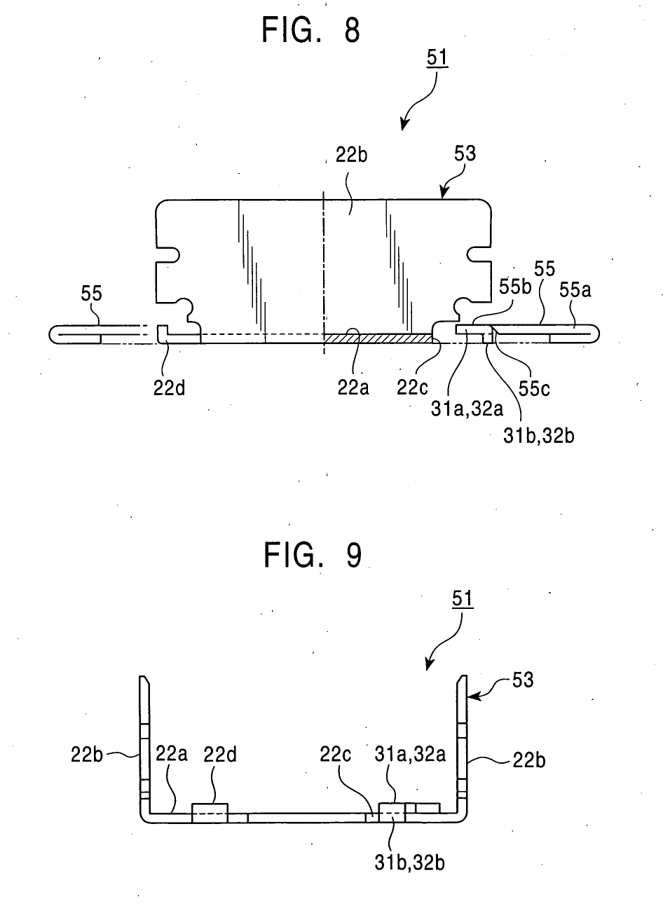

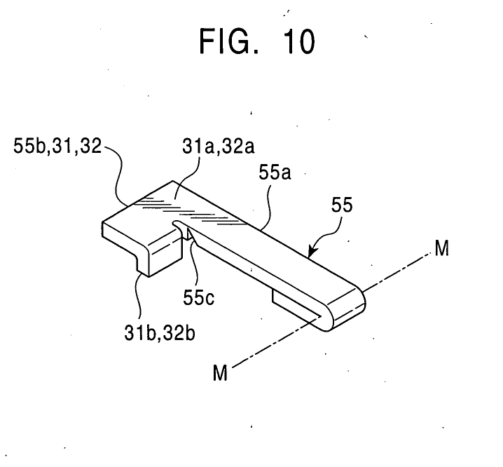

As shown in FIGS. 7 and 10, the independent terminal segments 55b become the independent terminals 31 and 32 of the isolator 1, and the widths of the independent terminal segments 55b are larger than those of the support segments 55a. In detail, one of the independent terminal segments 55b includes the terminal body 31a and the bent terminal segment 31b, while the other independent terminal segment 55b includes the terminal body 32a and the bent terminal segment 32b. The bent terminal segment 31b is provided at one end of the terminal body 31a, while the bent terminal segment 32b is provided at one end of the terminal body 32a. The support segments 55a are connected to the other ends of the bent terminal segments 31b and 32b. The bent terminal segments 31b and 32b are bent perpendicular to the terminal bodies 31a and 32a, respectively. Since the terminal bodies 31a and 32a are substantially parallel to the bottom yoke section 53, the bent terminal segments 31b and 32b are held perpendicular to the bottom yoke section 53. As shown in FIGS. 8 and 10, notches 55c are formed between the support segments 55a and the independent terminal segments 55b.

A process for manufacturing the isolator 1 using the lead frame 51 will now be described. Referring first to FIGS. 7 to 10, the fold sections 55, the bent terminal segments 31b and 32b, the ground terminals 22d, and walls 22b are bent by bending processing. The fold sections 55 are folded at the fold lines M such that the independent terminal segments 55b are accommodated in the cutouts 22c. In this manner, the longitudinal direction (direction perpendicular to the longitudinal direction of the support segments 55a) of the independent terminal segments 55b can be aligned with the width direction of the cutouts 22c.

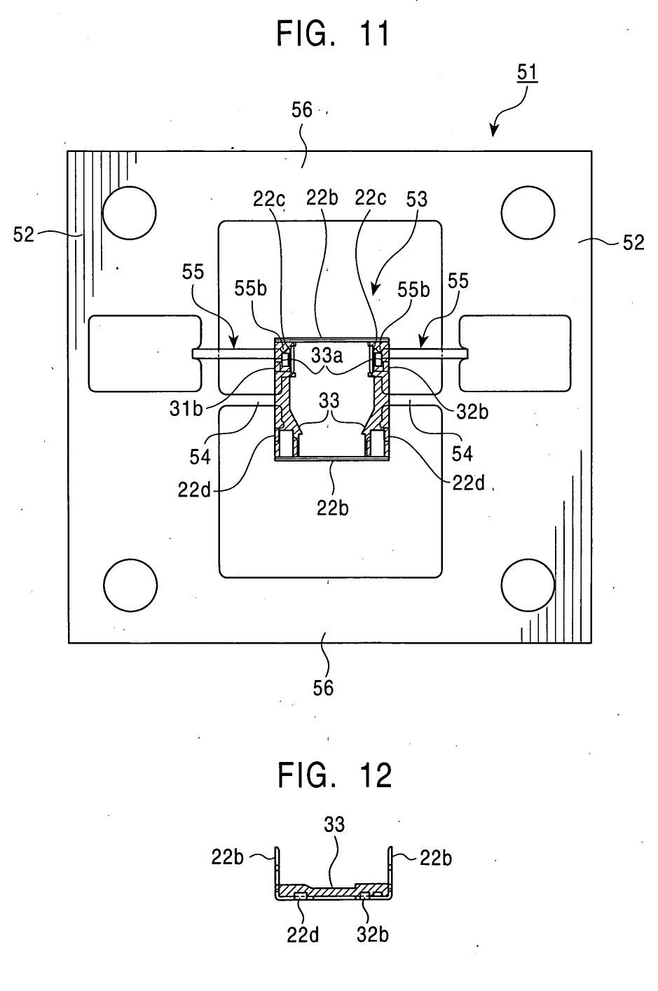

Referring then to FIGS. 11 and 12, the resin casings 33 are insert-molded by injecting resin onto the lead frame 51. The resin casings 33 are formed along both ends of the bottom yoke section 53 between the pair of walls 22b. The gaps between the cutouts 22c and the independent terminal segments 55b are also filled with resin. In this manner, the independent terminal segments 55b are insert-molded integrally with the bottom yoke section 53. As a result of this insert molding, the bent terminal segments 31b and 32b and the ground terminals 22d are exposed to the outside of the resin casings 33. Since the longitudinal direction of the independent terminal segments 55b is aligned with the width direction of the cutouts 22c, large contact areas between the independent terminal segments 55b and the resin casings 33 can be secured. The resin casings 33 are preferably provided with the windows 33a at the portions overlapping the terminal bodies 31a and 32a. Through these windows 33a, some portions of the terminal bodies 31a and 32a are exposed such that the ports P1 and P2 can be connected to the independent terminal segments 55b through the windows 33a.

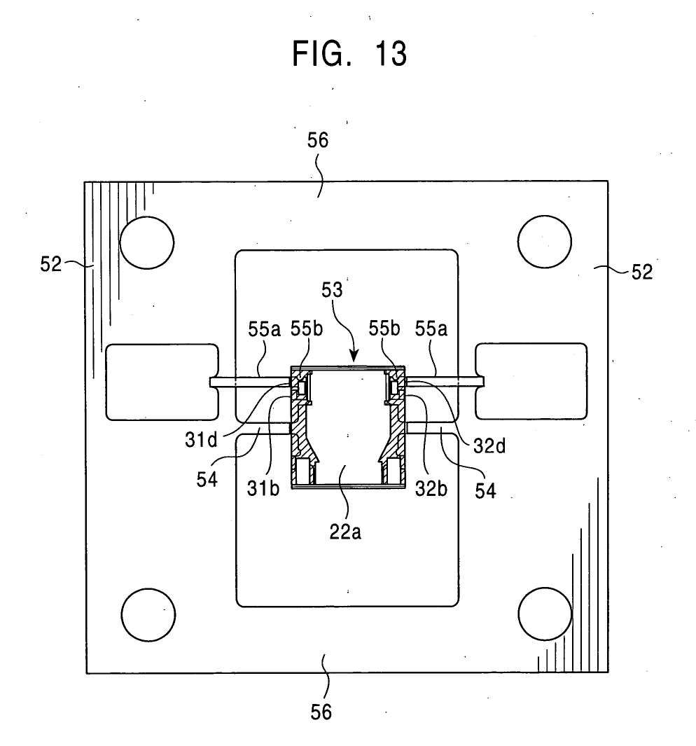

Referring now to FIG. 13, the independent terminal segments 55b are cut off the support segments 55a, and the base 22a of the bottom yoke section 53 is cut off the joints 54. The bottom yoke 22 of the isolator 1 is produced by cutting the bottom yoke section 53 from the side divisions 52 in the manner described above. Since the support segments 55a are joined with the terminal bodies 31a and 32a of the independent terminal segments 55b, the cut surfaces 31d and 32d where the underlying magnetic metal is exposed are formed on the terminal bodies 31a and 32a. On the other hand, a cut surface is not formed on the bent terminal segments 31b and 32b. In other words, the entire surfaces of the bent terminal segments 31b and 32b still have an anti-corrosion plating layer thereon.

Finally, the isolator 1 shown in FIG. 1 is manufactured by mounting the magnetic assembly 10, the plate capacitors 24 to 26, the chip resistor 27, and the permanent magnet 16 on the produced bottom yoke 22 and then fitting the top yoke 21 to the bottom yoke 22.

The bottom yoke 22 provided with the independent terminals 31 and 32 is produced by cutting the independent terminal segments 55b off the support segments 55a after insert molding by injecting resin between the independent terminal segments 55b and the cutouts 22c on the lead frame 51. Here, the cut surfaces 31d and 32d are unplated because they are cut after plating. In the lead frame 51, since the widths of the independent terminal segments 55b are larger than those of the support segments 55a, although the process of cutting off generates unplated portions on the independent terminal segments 55b, the other portions remain plated and can be used as input/output terminals. This improves solderability and prevents the occurrence of corrosion. Furthermore, large contact areas between the terminal bodies 31a and 32a and the resin casings 33 can be secured and thereby the independent terminals 31 and 32 can be firmly fixed to the bottom yoke 22. In addition, the extent of the cutouts 22c is small, that is, the area of the bottom yoke 22 is large. Therefore, the attenuation of the bias magnetic field can be decreased.

Furthermore, the notches 55c are provided between the support segments 55a and the independent terminal segments 55b, and therefore the independent terminal segments 55b can be cut off without applying an excessive force to the independent terminal segments 55b. This prevents the deformation of the independent terminal segments 55b and the occurrence of burrs on the cut surfaces 31d and 32d.

### EXAMPLE

The relationship among the depth of the cutouts 22c on the bottom yoke 22, the bias magnetic field for the magnetic plate 15, and out-of-band attenuation was examined.

In the following example, an isolator as described in the foregoing embodiment was used, with the exception of the size of the enclosure 20 (3.2 mm²), the width W and the depth D of the cutouts 22c (0.9 mm and 0.2 mm to 0.45 mm, respectively), and the longitudinal width W₁ of the terminal bodies 31a and 32a (0.6 mm). An operating frequency fₒ of the isolator was 1.88 GHz. The top yoke 21 and the bottom yoke 22 were made of 0.1 mm thick pure iron plated with Ag. The magnetic plate 15 was a non-equilateral hexagonal plate in plan view made of yttrium iron garnet ferrite. The size of the magnetic plate 15 in plan view was such that the lengths of the parallel facing long sides were 1.2 mm, the lengths of two facing sides of the other four sides were 0.67 mm and 0.9 mm, respectively, and the lengths of the remaining two sides were 0.67 mm and 0.98 mm, respectively. The thickness of the magnetic plate 15 was 0.35 mm. A ferrite magnet was used for the permanent magnet 16.

As a comparison example, another isolator was prepared which was as described in the foregoing embodiment with the exception of the width of the support segments 55a of the lead frame 51 and the width W₁ of the terminal bodies 31a and 31b (both 0.25 mm), and the width (0.9 mm) and the depth D (0.6 mm) of the cutouts 22c.

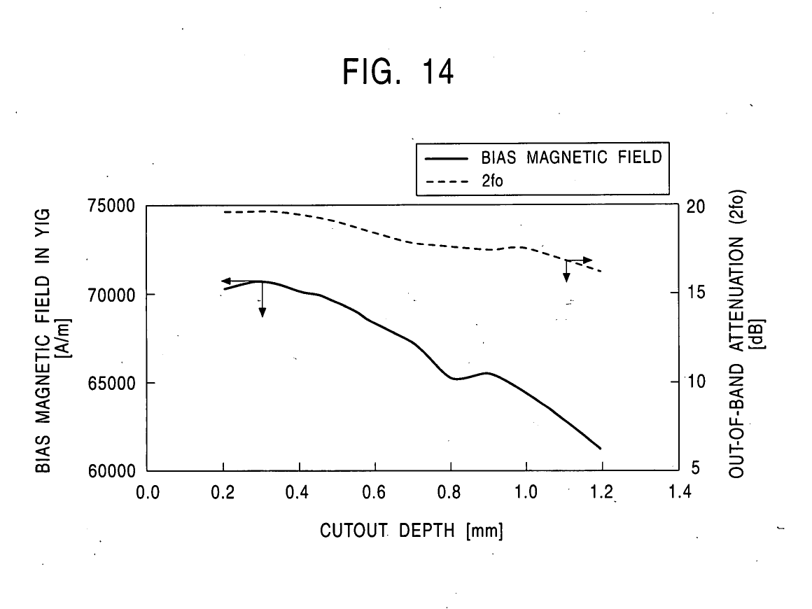

FIG. 14 shows the results. The out-of-band attenuation is the attenuation in a signal of the isolator at the frequency 2fₒ. The larger the out-of-band attenuation, the higher the characteristics of the isolator.

FIG. 14 indicates that since the depth D for the isolator in this example was 0.2 mm to 0.45 mm, a bias magnetic field with an intensity as high as 69000 to 70000 (A/m) was produced, and therefore the thickness of the permanent magnet 16 can be reduced to reduce the thickness of the entire isolator. In contrast, the isolator prepared for comparison had an intensity of 68000 (A/m), which is lower than that of the isolator in the example. The out-of-band attenuation 2fₒ of the isolator used in the example was 19 to 19.5 dB, while that of the isolator prepared for comparison was 18 db. Consequently, the isolator in the example was superior to the isolator prepared for comparison.

As shown in FIG. 14, the larger the depths D of the cutouts 22c, the lower the bias magnetic field becomes for the magnetic plate 15. This may be because a large depth D of the cutouts 22c, that is, a large extent of the cutouts 22c on the bottom yoke 22 functioned as a magnetic resistance to decrease the bias magnetic field.

Also, the larger the depth D of the cutouts 22c, the lower the out-of-band attenuation became. The out-of-band attenuation was decreased due to a decrease in the bias magnetic field for the magnetic plate 15. This shows that as the depth D of the cutouts 22c becomes larger, the characteristics of the isolator decrease.

Consequently, the characteristics of the isolator can be increased by decreasing the depth D of the cutouts 22c.

The scope of the present invention is not limited to the embodiment described above. For example, a polygonal magnetic plate may be used instead of the circular magnetic plate. Although the central conductors in FIG. 2 have a slit, central conductors without a slit may be used. The shapes of the central conductors are not limited to those shown in FIG. 2. The central conductors may be tortuous or V-shaped. Furthermore, any type of anti-corrosion plating that is superior in resistance to corrosion and wettability of solder is acceptable. An anti-corrosion agent such as solder plating or cold-setting, heat-setting, or ultraviolet-curing resist or coating can be used.

1. A nonreciprocal circuit element comprising:
a parallelepiped enclosure;
a permanent magnet disposed in the enclosure; and
a magnetic assembly disposed in the enclosure, the magnetic assembly including:
a magnetic plate;
a common electrode on the magnetic plate; and
a plurality of central conductors on the magnetic plate,
wherein a length of a long side of the enclosure is 3.5 mm or less and a pair of independent terminals connected to at least one of the central conductors are disposed substantially in a contour of the enclosure.

2. The nonreciprocal circuit element according to claim 1, wherein the enclosure includes a top yoke and a bottom yoke, the top yoke includes two parallel side plates defining side wall surfaces of the enclosure, the bottom yoke includes cutouts of which a width is larger than a depth, a width direction of the cutouts being substantially identical to a direction of the side wall surfaces, the independent terminals are disposed in the cutouts, and the bottom yoke is integrated with the independent terminals with resin.

3. The nonreciprocal circuit element according to claim 2, wherein each of the independent terminals includes a terminal body and a bent terminal segment formed by bending one end of the terminal body and a longitudinal direction of the terminal body is aligned with the width direction of the corresponding cutout.

4. The nonreciprocal circuit element according to claim 3, wherein each of the bent terminal segments is exposed to the outside of the corresponding side wall surface of the enclosure.

5. The nonreciprocal circuit element according to claim 3, wherein an entire surface of each of the bent terminal segments has an anti-corrosion plating layer.

6. The nonreciprocal circuit element according to claim 3, wherein an opposing end of each of the terminal bodies is exposed to the outside of the corresponding side wall surface and an entire surface of each of the terminal bodies, except for the exposed portion, has an anti-corrosion plating layer.

7. The nonreciprocal circuit element according to claim 6, wherein at least one part of the exposed portion has an anti-corrosion coating layer.

8. A communication apparatus including the nonreciprocal circuit element according to claim 1.

9. A lead frame for a nonreciprocal circuit element, comprising:
a hoop including:
a pair of side divisions, each of which includes a fold section formed by die-cutting a portion of the side division into a substantial bold U shape, the fold section including a support segment extending from an inner edge toward an outer edge of the portion of the side division and an independent terminal segment formed at an end of the support segment, the independent terminal segment being wider than the support segment; and
a bottom yoke section between the side divisions, the bottom yoke section including a pair of cutouts of which a width is larger than a depth,
wherein each of the independent terminal segments is positionally symmetrical with the corresponding cutout with respect to a fold line of the corresponding fold section.

10. A lead frame for a nonreciprocal circuit element, comprising:
a hoop including:
a pair of side divisions; and
a bottom yoke section between the side divisions, the bottom yoke section including a pair of cutouts of which a width is larger than a depth,
wherein each of the side divisions includes a fold section formed by die-cutting a portion of the side division into a substantial bold U shape and bent towards the bottom yoke section, the fold section including a support segment extending from an inner edge of the portion and an independent terminal segment formed at an end of the support segment, the independent terminal segment being wider than the support segment, and the independent terminal segments are disposed in the respective cutouts.

11. The lead frame for a nonreciprocal circuit element according to claim 9, wherein each of the independent terminal segments includes a terminal body and a bent terminal segment formed by bending one end of the terminal body, the support segment being joined with an opposing end of the terminal body.

12. The lead frame for a nonreciprocal circuit element according to claim 11, wherein each of the bent terminal segments is perpendicular to the bottom yoke section.

13. The lead frame for a nonreciprocal circuit element according to claim 9, each of the fold sections further including a notch between the support segment and the independent terminal segment.

14. The lead frame for a nonreciprocal circuit element according to claim 9, wherein an entire surface of the lead frame has an anti-corrosion plating layer.

15. A method for manufacturing a nonreciprocal circuit element, the method comprising:
die-cutting a hoop to form a bottom yoke section having a pair of cutouts of which a width is larger than a depth and a pair of fold sections each including a support segment and an independent terminal segment wider than the support segment, the bottom yoke section being joined with the fold sections by the hoop;
folding each of the fold sections towards the bottom yoke section such that each of the independent terminal segments is disposed in the corresponding cutout by aligning a longitudinal direction of the independent terminal segment with a width direction of the cutout;
integrally insert-molding the bottom yoke section and the independent terminal segments with resin; and
cutting off the bottom yoke section and the independent terminal segments from the hoop to produce a bottom yoke.
